(19) United States
(12) Patent Application Publication
(10) Pub. No.: US 2018/0164872 A1
(43) Pub. Date: Jun. 14, 2018

(54) POWER MANAGEMENT AND DEEP-DISCHARGE PROTECTION

(71) Applicant: MAQUET GMBH, RASTATT (DE)

(72) Inventors: Heiko GRAF, Worth (DE); Michael FRÜH, Achern (DE)

(73) Assignee: MAQUET GMBH, RASTATT (DE)

(21) Appl. No.: 15/890,169

(22) Filed: Feb. 6, 2018

Related U.S. Application Data
(63) Continuation-in-part of application No. PCT/EP2016/067488, filed on Jul. 22, 2016.

(30) Foreign Application Priority Data
Aug. 7, 2015 (DE) 10 2015 113 074.2

(51) Int. Cl. G06F 1/32; A61G 13/08; A61G 13/12

(52) U.S. Cl. CPC G06F 1/3293; A61G 13/1285; A61G 13/08; G06F 1/3287

(57) ABSTRACT

A power-saving control device for a battery-operated operating table, and related tables and methods. The control device can include two microprocessors for controlling the operating table. An input device may send instructions the microprocessors via an input channel. The control device may have at least a sleep state, a check state, and an active state. Typically, in the sleep state, the first microprocessor monitors an input channel of the input device, and the second microprocessor is off. Upon receipt of an instruction, the control device switches from the sleep state to the check state in order to check whether the instruction includes a valid wake-up signal. This may include determining whether the instruction includes an address of the battery-operated operating table. When a valid wake-up signal has been received, the control device to an active state where, typically, both microprocessors are active.

### CROSS-REFERENCE TO RELATED APPLICATIONS

The present application is a continuation-in-part filed under 35 U.S.C. § 111(a), and claims the benefit under 35 U.S.C. § 365(c) of PCT International Application No. PCT/EP2016/067488, filed Jul. 22, 2016, which designates the United States of America, and claims the benefit of German Patent Application No. 10 2015 113 074.2, filed Aug. 7, 2015. The disclosure of each of these applications is incorporated by reference herein in its entirety.

### BACKGROUND

The present disclosure relates to an apparatus/device and method for controlling battery-operated devices, such as mobile operating tables.

In standard operation, power for mobile operating tables is supplied by batteries, meaning that the network connection is only established in order to charge the batteries. Therefore, the amount of power available is limited and must be used sparingly. If at a particular time the operation tables are not being used, they will usually be in standby mode, meaning that they will respond immediately to an instruction from one of their input devices without having to be switched on first. It is therefore necessary that in standby mode, at least part of the electronics of the operation tables must be permanently supplied with power, as a result of which the batteries are discharged continuously.

A characteristic of the (lead) batteries is that they lose their capacity, that is, their ability to store power when they are stored without a charge or when they are discharged beyond a certain level. One problem is that especially when in storage or during transportation, when the operating tables cannot be charged, the batteries are continuously discharged.

Furthermore, higher demands from the software in terms of controlling the operating tables require ever more powerful microcontrollers with a high-power capacity, and therefore a high-power consumption during the operation of the operating table. In order to ensure a reliable long operating time of the mobile operating table, it is therefore necessary to use the power stored in the batteries as sparingly as possible.

In order to realize the standby mode, some additional microcontrollers are used with a low power capacity, which monitor the input devices and wake up the main controllers by activating their power supply, as necessary. The use of additional controllers has the disadvantage, however, that the system becomes more complex, and as a result more prone to errors and less cost-effective. The additional microcontrollers require their own software, they involve manufacturing and maintenance costs, they increase the space requirements of the control apparatus and lead to an increased amount of documentation.

One task of the present disclosure is therefore to provide an apparatus and a method for controlling a battery-operated device, such as, for instance, an operating table, in which the power consumption of the device is minimized, and the discharge of the battery (batteries) used in the instrument(s) is minimized accordingly, at the lowest possible manufacturing costs and space requirements.

A further task of the present disclosure is to provide an apparatus with which the life of the battery or batteries supplying power to the battery-operated device can be maximized by means of one or more batteries.

### SUMMARY

This task is accomplished according to a first aspect by way of a control apparatus/control device for a battery-operated device, such as an operating table, for instance, comprising at least two microprocessors for controlling components of the battery-operated device, and at least one input device, which can send instructions to at least one of the microprocessors by means of an input channel. The input device may be a wireless or a wired input device, or a so-called override panel may be provided on the battery-operated device, by means of which a user can send instructions to the control apparatus, for instance by actuating buttons, switches or a membrane keypad.

The first microprocessor is designed such that it can be brought into an idle state in which the input channel of the input device is monitored, the second microprocessor being switched off. Such an idle state, in which a microprocessor is completely switched off and the other merely monitors one or a small number of input channels, allows for an energy-efficient standby mode of the control apparatus. Furthermore, the first microprocessor is further designed in such a way that when an instruction is received from the input device, it first puts itself and then the second microprocessor into an active state. As a result, a user may terminate the standby mode by actuating an input device, and cause the two microprocessors to be powered up and put in their active state in which they may, for instance, control the movement of a back plate, of leg plates, head plates, hip plates, or other components of the operating table or of another battery-operated device. For the standby mode, the same microprocessors are used as those that are also responsible in the active state of the control apparatus for controlling the components of the battery-operated device and for the functionality of the control apparatus. Thus, no separate microcontrollers are needed to accomplish this power-saving standby mode. The production, maintenance, and documentation costs and the space requirements of the control apparatus can therefore be minimized.

According to some embodiments, it may be provided that the microprocessors are coupled in a master-supervisor structure. In this way, a high degree of safety can be ensured in the active state of the control apparatus, since one of the microprocessors, for instance the second microprocessor, may serve as a supervisor checking and monitoring the output of the first processor, which serves as a master processor.

According to some embodiments, the first microprocessor may comprise a power-saving circuit (a hibernate domain), designed such that it monitors the input channel while the power consumption of the first microprocessor in the idle state is reduced as compared to the active state. By means of the power-saving circuit, the power capacity of the first microprocessor can thus be reduced in the idle state.

According to some embodiments, the control apparatus may comprise at least one connection for at least one battery for powering the battery-operated device. Furthermore, an electromechanical switch may be provided, by means of which the connection for the at least one battery can be electrically disconnected from the control apparatus. A deep discharge of the battery can thus be effectively prevented, even in case of long-term storage of the battery-operated device, because the battery can be completely isolated electrically from the control apparatus by the electromechanical switch, which may, for instance, be designed as a relay.

It may be provided that after a predetermined period of time from the most recent charge and/or when [the battery has] discharged below a predetermined voltage value and/or when a respective instruction is received from the input device, the connection of the at least one battery is electrically disconnected from the control apparatus by means of the electromechanical switch. Thus, the electrical disconnection of the battery or batteries may be accomplished either automatically after a predetermined period of time, or at a predetermined discharge state of the battery or batteries, or when the disconnection is ordered by a user via the input device.

According to further aspect, a method for controlling a battery-operated device, such as, for instance, an operating table, is provided, the method comprising the putting of a control apparatus comprising at least two microprocessors for controlling components of the battery-operated device in an idle state, in which a first microprocessor monitors an input channel of an input device, the second microprocessor being switched off. Thus, a standby state is provided in which the power consumption is reduced in that only one of the microprocessors is active, and merely monitors one or a small number of input channels. When an instruction is received on a monitored input channel, the control apparatus is put into an active state, in which the first and the second microprocessor) control the movement of components of the battery-operated device.

According to some embodiments, the control apparatus may be put from the idle state into a check state, when an instruction is received on the input channel to check whether the instruction received comprises a valid wake-up signal. This may briefly activate the first microprocessor in order to analyze the instruction received.

In the test condition, it might, for instance, be possible to check whether the instruction received contains a valid address of the battery-operated device. If this is the case, the instruction received relates to the battery-operated device connected to the control apparatus, and the control apparatus may then be put into the active state. If the instruction does not comprise a valid address of the battery-operated device, it is possible that the instruction was sent, for instance, from a wireless input device to another device, and that it is not a wake-up signal for the device in the idle state. The first microprocessor, which had been activated in the check state, may then return to the power-saving idle state in which the input channel continues to be monitored.

According to some embodiments, the control apparatus may be placed in an awake state before the control apparatus is put into the active state, such that in the awake state, the first microprocessor is active, the second microprocessor is switched on and the movement of the components of the battery-operated device is switched off. Thus, in the awake state, the first microprocessor is prevented from controlling the components of the battery-operated device before the second microprocessor is active and able to monitor the actions of the first microprocessor, for instance in the event of a malfunction.

According to a third aspect, a control apparatus for a battery-operated device such as, for instance, an operating table is provided, comprising a connection for at least one battery to power the battery-operated device and further comprising an electro-mechanical switch, by means of which the connection of the at least one battery can be electrically disconnected from the control apparatus. The control apparatus is designed such that the connection of the battery is electrically disconnected by the switch after a predetermined period of time from the most recent charge and/or when [the battery has] discharged below a predetermined voltage value and/or when a respective instruction is received from the input device. Thus, a deep discharge of the battery or batteries can be effectively prevented, since a complete electrical disconnection between the control apparatus can be achieved and the battery or batteries can be accomplished either automatically, for instance, depending on the period of time since the most recent charge or as a function of the charge state of the battery or batteries, or manually, by way of user input.

Embodiments a control apparatus for a battery-operated device such as an operating table, comprising: at least two microprocessors for controlling components of the battery-operated device, and at least one input device, which can send instructions to at least one of the microprocessors by means of an input channel. It may be characterized in that a first microprocessor is designed in such a way that it can be put into an idle state, in which the input channel of the input device is monitored, while the second microprocessor is switched off, and in that the first microprocessor is furthermore designed in such a way that when an instruction is received from the input device, it first puts itself and then the second microprocessor into an active state. Optionally, the arrangement is characterized in that the microprocessors is coupled in a master-supervisor structure. Optionally, the arrangement is characterized in that the first microprocessor comprises a power-saving circuit, which is designed such that it monitors the input channel, while the power consumption of the first microprocessor is reduced in the idle state as compared to the active state is. Arrangements may include at least one connection for at least one battery for powering the battery-operated device, and an electromechanical switch, by means of which the connection for the at least a battery can be electrically disconnected by the control apparatus.

Useful embodiments are designed such that the connection of the at least one battery by means of the electromechanical switch is electrically disconnected from the control apparatus after a predetermined period of time from the most recent charge and/or when the battery has discharged below a predetermined voltage value and/or when a respective instruction is received from the input device.

Useful methods of controlling a battery-operated device, such as an operating table, can include:

putting a control apparatus comprising at least two microprocessors for controlling components of the battery-operated device in an idle state, in which a first microprocessor monitors an input channel of an input device, with the second microprocessor being switched off. When an instruction is received on an input channel, the control apparatus can be put into an active state in which the first and the second microprocessor control the movement of components of the battery-operated device. Some methods further include the switching of the control apparatus from the idle state into a check state when an instruction is received on the input channel in order to check whether the instruction received comprises a valid wake-up signal. Useful methods further include checking whether the instruction received includes an address of the battery-operated device. Methods optionally include putting of the control apparatus into an awake state before the control apparatus is put into the active state. In a useful embodiment of the awake state, the first microprocessor is active, the second microprocessor is switched on, and the movement of the components of the battery-operated device is deactivated.

Disclosure includes control apparatuses for battery-operated devices, such as an operating table. The devices can include at least one connection for at least one battery for powering the battery-operated device, and an electromechanical switch, by means of which the connection for the at least one battery can be electrically disconnected from the control apparatus. Optionally the control apparatus is designed such that the connection of the battery by means of the electromechanical switch is electrically disconnected from the control apparatus after a predetermined period of time from the most recent charge and/or when the battery has discharged below a predetermined voltage value and/or when a respective instruction is received from the input device.

The present disclosure includes battery operated operating tables, other battery-operated arrangements, batteries and controllers for use with such tables, and related methods and processes.

Further features and benefits of the embodiments of the present disclosure will emerge from the following description explaining aspects of the invention more closely with the aid of sample embodiments in connection with the enclosed figures.

Embodiments include a control device for a battery-operated operating table, the control device comprising: at least two microprocessors for controlling components of the battery-operated operating table; at least one input device adapted to send instructions to at least one of the microprocessors by means of an put channel. The control device, as a whole, may have a sleep state, a check state, and an active state. The control device can be configured such that in the sleep state thereof: the first microprocessor is in an idle state, the first microprocessor monitors the input channel of the input device, and the second microprocessor is off. In embodiments, the first microprocessor is further configured to, upon receipt of an instruction from the input device, switch the control device from the sleep state to the check state in order to check whether the instruction includes a valid wake-up signal. The control apparatus can be adapted wherein the checking includes determining whether the instruction includes an address of the battery-operated operating table, and then, when a valid wake-up signal has been received, to set the control device to an active state. Typically, the first microprocessor and second microprocessor are both active in the active state. Optionally, the first and second microprocessors are coupled, respectively, in a master-supervisor structure. Optionally, the first microprocessor comprises a power-saving circuit, and is configured such that power consumption of the first microprocessor is lower in the idle state as compared to the active state.

Some embodiments include at least one connection for connecting to at least one battery for powering the battery-operated table; and an electromechanical switch, by means of which the connection for the at least one battery can be electrically disconnected by the control apparatus.

In some embodiments the control apparatus is configured wherein the connection of the at least one battery is electrically disconnected from the control apparatus by means of the electromechanical switch: (i) after a predetermined period of time since the most recent charge and/or (ii) when the battery has discharged below a predetermined voltage value.

The disclosure includes a battery-operated operating table, comprising: a control apparatus, at least one table surface for holding a patient thereon, and a battery. Embodiments include at least one motor connected to the battery, the at least one motor configured to at least one of: (i) raise and lower the table surface, and/or (ii) change the orientation of the table surface, and/or (iii) move one or more sections of the table surface with respect to other sections of the table surface to thereby change an overall shape of the table surface. For example, raising and lowering leg plates, back plates, head plates, and the like. Embodiments include least one input device comprises user control for adjusting the table surface using the at least one motor, the control apparatus being configured wherein instructions from the input device to adjust the table surface using the at least one motor are considered and interpreted to be a valid wake-up signal.

Methods of operating a battery-operated operating table are provided. In some methods the control device is initially in the sleep state. It can then receive an input with the input device, and the input device in response sends an instruction to at least the first microprocessor. The first microprocessor, potentially in the idle state, monitors the input channel and receives the instruction. The first microprocessor may, when appropriate, determine that the instruction comprises the address of the battery-operated operating table and, in response to the determination, further determine that the instruction includes a valid wake-up signal. Typically, in response to determining that the instruction includes a valid wake-up signal, the arrangement sets the control device to the active state, with the first processor and the second processor both being active. In some instances the input may be a signal or request to move or adjust the table or table plates. For example, a signal created by a user input into a user interface. In these cases, in response to determining that the instruction includes a valid wake-up signal, the control device may be set to the active state, and, further, portions of the table are moved, lifted, tilted, or the like. For example, adjustable leg plates may be raised or lowered.

Some embodiments include an electromechanical switch, the electromechanical switch being positioned for controlling an electrical connection between the control device and the battery. The battery-operated table may be configured wherein the electromechanical switch disconnects the control device and the battery in response to at least one of:

passage of a predetermined period of time since a most recent charge of the battery; and/or

the battery discharging below a predetermined voltage value.

Further features, benefits, and embodiments of the present disclosure will emerge from the following description explaining aspects of the disclosure more closely, with the aid of sample embodiments in connection with the enclosed figures.

### BRIEF DESCRIPTION OF THE DRAWINGS

Exemplary embodiments of the present invention are described below with reference to the appended drawings, in which identical reference signs designate respective identical or corresponding elements.

FIG. 1 is a schematic representation of an operating table.

FIG. 2 is a schematic representation of a control apparatus for an operating table according to one embodiment.

FIG. 3 is a flow chart of the operating states of the control apparatus of FIG. 1.

### DETAILED DESCRIPTION

In the following description, exemplary embodiments of the present invention will be described with reference to the drawings. The drawings are not necessarily true to scale; they are merely intended to schematically illustrate the respective characteristics.

It should be noted that the characteristics and components described below can be respectively combined with each other, independently of whether they have been described in the context of a single embodiment. The combination of characteristics in the respective embodiments is merely intended to illustrate the basic structure and functions of the claimed device and the claimed method. In order to avoid unnecessary repetitions, individual aspects are described in connection with respective embodiments of a device or a method. Characteristics of the method may also be used in the device, and vice versa, whereas individual aspects of the method may be combined with individual aspects of the device, and vice versa.

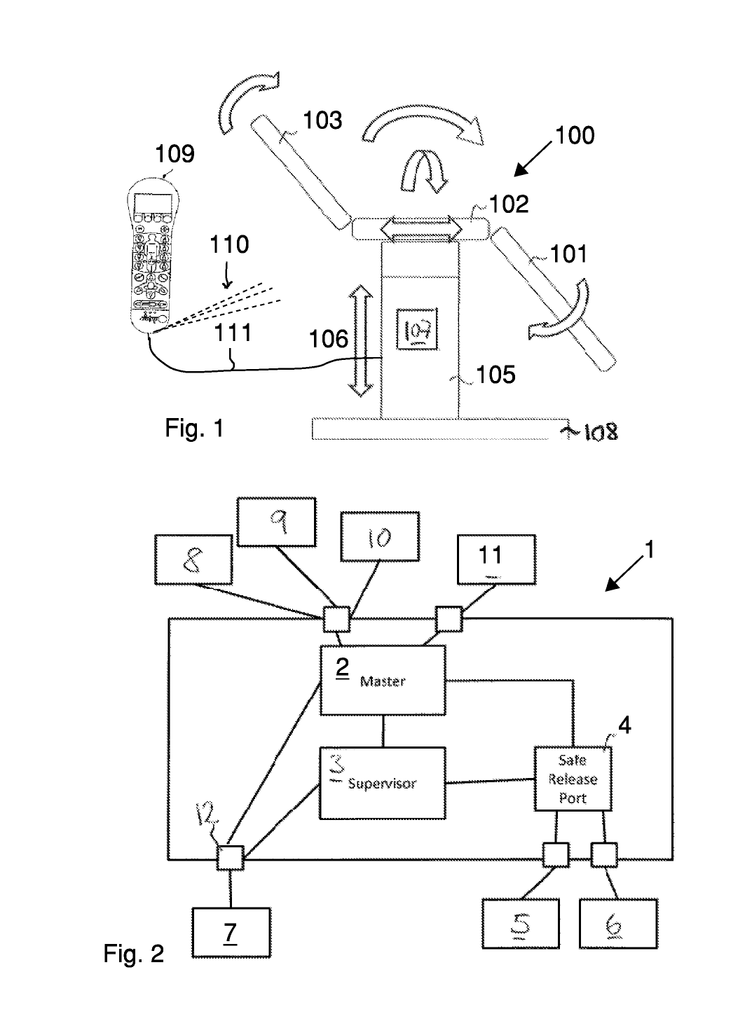

FIG. 1 shows a schematic view of an operating table 100, which has a modular construction and comprises a plurality of movable components. For instance, a bearing surface of the operating table 100 for a patient may be subdivided several times, into one or several leg plates 101, one or several hip plates 102, and one or several back plates 103. According to other embodiments, one or several head plates and/or other components may be additionally provided. These components 101-103 may be respectively movable relative to each other and relative to a column 105 of the operating table 100. The column 105 may comprise a lifting mechanism 106 for adjusting the height of the operating table 100.

As schematically shown by the respective arrows in FIG. 1, a plurality of different axes of motion may be provided by for each of the components 101-103, for instance in order to adjust the inclination or lateral tilt of individual components with respect to each other and/or to the column 105, and in order to set a plurality of positions, such as for the head, the torso, and the legs. Furthermore, it may be provided that the components 101-103 are moveable in the longitudinal direction of the operating table relative to the column 105.

The upward and longitudinal movements and/or the tilting of the back plate 103 and/or the leg plates 101 may be generated using a motor, for which hydraulic, pneumatic or electric systems may be used. A control apparatus/control device 107 may be accommodated in the column 105 in order to control the movements of the components 101-103. The power supply for the control apparatus 107 and for the respective drives of the components 101-103 may be accomplished via batteries which may be arranged in a toot 108 of the operating table 100.

FIG. 1 depicts one possible input device 109, in the form of a hand held remote control 109 having control buttons and a display screen. A wire 111 or wireless link 110 may be used to operably connect the input device 109 to the control apparatus/control device 107 and/or to other elements of an operating table. The input device can include controls, such as buttons, for moving the plates of an operating table, and/or for raising, lowering, or tilting the operating table. The input device can also be on the operating table 100 itself, or can include a remote computer or internet connection.

FIG. 2 shows a schematic representation of an apparatus 1 for controlling a battery-operated device, such as might be used, for instance, as a control apparatus 107 of the operating table 100 shown in FIG. 1. For safety reasons, an architecture is used in which a master processor 2 and a supervisor 3 (monitoring processor) are provided. Only if both processors 2, 3 are active, a switch 4 (safe release port) is activated, which switches on the power supply to at least one motor 5 and at least one valve 6 for a hydraulic adjustment of components of the device. As soon as the safe release port 4 is switched on, control signals can be transmitted from the processors to the motor 5 and valve 6. Instead of a hydraulic adjustment by means of a pump by driven by the motor 5 and of at least one valve 6, an electro-motor adjustment may also be provided. In this case, the safe release port 4 activates the power supply to the respective electric motors which are then controlled by control signals from the processors.

The power supply to the master processor 2 and the supervisor 3 are accomplished via a battery 7 which is or are accommodated, for instance, in the foot 108 of the operating table 100. The different operating voltages for the operation of the processors 2, 3 and of the drives 5, 6 are generated in the control apparatus 107. For this purpose, the battery 7 may provide, for instance, a voltage of 24V, from which other voltages can then be generated in the control apparatus 107 for the operation of individual processors and components by means of DC converters.

A user may use a plurality of input devices, such as an infrared remote control 8, a foot switch 9, or a wired control unit 10 to enter instructions to the device 1. Furthermore, a so-called override 11 may be provided as a control panel directly at the operating table 100, for instance on the column 105, allowing the user to send instructions to the device 1 even without connecting external input devices.

If one or more batteries 7 are provided by way of a power supply an electro-mechanical (relay) switch 12 may be integrated in the interface between the battery 7 and the control apparatus 1. Alternatively, the relay switch 12 may also be formed separately and connected with the interface between the battery 7 and the control apparatus 1. Controlled by a timing circuit, the battery 7 can then be disconnected from the control apparatus 1 after a certain period of inactivity. For instance, such a disconnection may be effected when a predetermined period of time has elapsed since the most recent charge.

Alternatively or additionally, the at least one battery 7 can be disconnected by means of the switch 12 when the voltage falls below a certain value, which corresponds to a highly discharged state. This can prevent deep discharge of the battery or batteries 7.

Alternatively or additionally, according to some embodiments, the deep discharge of the battery or batteries 7 may also be manually activated via a key combination on one of the input devices 8-10 or on the override 11. When an operating table is meant to be stored or for extended transportation, the batteries 7 may be disconnected immediately after charging by means of the switch 12 in order to ensure that the operating table is stored with fully charged batteries 7.

The discharge protection can then be automatically deactivated by plugging in or connecting the charging cable.

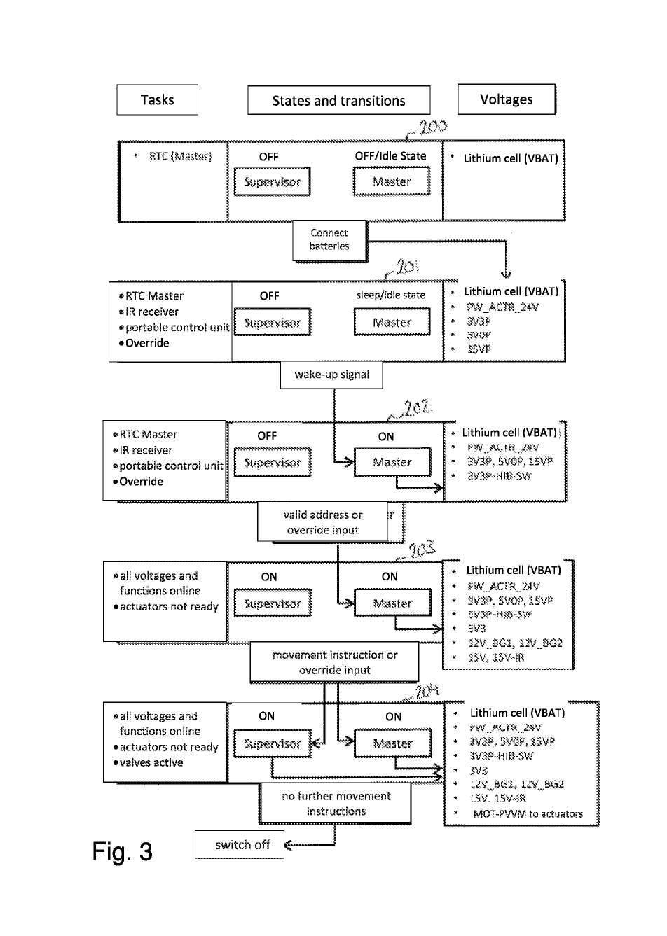

FIG. 3 shows an overview of the various operating states of the apparatus 1. In the embodiment shown in FIG. 3, the control apparatus 1 is used for controlling an operating table, such as the operating table 100 shown in FIG. 1. However, the control apparatus 1 may also be used for controlling another battery-operated device, with which substantially the same operating conditions can be provided as described below.

In the schematic flow chart shown in FIG. 3, the apparatus 1 is initially in a switched-off state 200, in which the peripherals and the supervisor 3, are switched off and without power, and the master processor 2 is either switched off or in an idle state. In this switched-off state, no input via the input device 8-10 or the override 11 is possible. Only the real-time clock (RTC) of the master processor is active and powered from its own battery, for instance a lithium cell (button cell). Furthermore, even in the switched-off state, a memory module that may serve as a parameter memory for operating the control apparatus 1 may be active. The operating table is in the switched-off state 200 during transportation and storage, for instance, after the control apparatus 1 of the operating table was either switched off by a user completely, or after a timer has determined that over a certain period, no control signals were sent to the control apparatus.

The control apparatus 1 is moved from the off state 200 into the sleep state 201 when the battery or batteries 7 are connected. In the sleep state 201, the supervisor 3 remains switched off as before and without power, but the master processor 2 is in a sleep state or in an idle state, which is a power-saving mode in which some or all of the input devices 8-10 and/or the override 11 are monitored.

At least some of the various operating voltages, such as a 24V power supply for the actuators 5, 6 for moving the components of the operating table, and operating voltages of 3V, 5V, and 15V for operating the processors 2, 3 and other electronic components of the control apparatus 1, are provided in the sleep state 201, even if the corresponding actuators or components are not yet active.

Thus, a power-saving sleep state 201 is provided, in which the power capacity of the control apparatus 1 is very low, since almost all the processors and components are unpowered, whereas the master processor is maintained in an energy-efficient sleep or idle state, monitoring the input channels of the input devices 810 and/or of the override 11.

When in the sleep state 201 a signal is detected at an input channel of the input devices 8-10 and/or the override 11, the operating voltage (in the present example: 3V) of the master processor 2 is activated in a check state 202, and the master processor 2 is started. If the signal received at the input channel of the respective input device was verified, for instance, by checking whether it contains a valid operating table address, and therefore, that it is intended for this operating table, the control apparatus 1 switches into an awake state 203. If the verification indicates that the received signal is not valid, for instance because it is not intended for the operating table, the master processor 2 goes back into its sleep or idle state, and the control apparatus 1 returns to the aforementioned sleep state 201.

If the signal was entered via an override operation, meaning that it was entered via a control firmly connected to the table, for instance at the base 105 of an operating table 100, the aforementioned test for a valid operating table address can be dispensed with, since in that case it is obvious that the wake-up signal is intended for the operating table associated with the control apparatus 1. By way of protection against an inadvertent faulty operation, it may be provided that a valid wake-up signal via the override panel 11 of must consist of at least two user inputs, for instance, such as pressing at least two keys or buttons or entering a predetermined sequence.

In the awake state 203, the supervisor 3 is activated, and the operating voltages that had not yet been provided in the previous operating conditions are switched on. This means that in the awake state 203, all functions and voltages of the control apparatus 1 are online, bait that the actuators 5, 6 for moving components 101-103 of the operating table 100 are not yet activated.

Now, if a movement instruction is received on an input device channel and/or the override, the master processor 2 enters into the active state 204 of the control apparatus 1 by activating the actuators to move the components of the operating table 100. In this active state 204, a user may control the movement of the components 101-103 of the operating table 100 by means of the input devices 8-10 and/or the override 11, in which the control apparatus, in addition to controlling the actuators such as the pump motor 5 and the valves 6 of a hydraulic adjustment element (see FIG. 2), may also have additional functions, such as a collision control or accessing stored positions of the operating table.

In the embodiment shown in FIG. 3, the control apparatus 1 may be switched off when a respective stimulus is received via one of the input devices 8-10. Alternatively, or additionally, a switch-off signal may be received or generated by any other means, for instance, by way of a “time out” when a predetermined time has elapsed since the last movement instruction.

When switching off the control apparatus 1, the master processor 2 will initially inform other processors about the shutdown, such as, for instance, the supervisor 3 and other processors of the control apparatus 1 that are not further described here. This allows all the processors to save their permanent data before switching off.

Once the data of all the processors used in the control apparatus 1 are secured, the master processor 2 will switch off the power supply of the operating table. Initially, all components except for the master processor 2, and in particular the supervisor 3, are switched off, such that the safe release port 4 is switched off as well. This may prevent movement instructions to move components of the operating table or of another battery-operated device from being inadvertently sent to the actuators due to the malfunctioning of the master. Finally, the master processor 2 puts itself in the idle state, so that the control apparatus 1 is restored to the sleep state 201.

In summary, therefore, the sleep state 201 accomplishes a standby mode in the control apparatus 1 in which the power consumption of the control apparatus 1 is very low. Furthermore, the control apparatus 1 can be quickly and easily changed by a user from standby mode into an active operating state in which all functions of the control apparatus 1 are available.

Since in the method described above for switching the control apparatus 1 on and off, there is a situation in which the master processor 2 is active alone, without the supervisor 3 being active as well, it is ensured that the system is first-fault protected in every state. This is accomplished in that the periphery, which is able to trigger movements, will only be activated or switched on when the supervisor 3 is also awake, that is, that a monitoring of the actions of the master processor 2 can occur.

In the power management [apparatus] described above, only the two main controllers will be needed that also ensure the active operation of the control apparatus 1, without a need for additional microcontrollers for the standby mode or for the wake-up or switching-off processes. In the present embodiment, the power management [apparatus] is controlled by the master processor 2, which is equipped with a special power-saving circuit hibernate domain that makes possible a power-saving mode, which is particularly economical and yet allows for the waking up of the control apparatus 1.

Auxiliary controllers for a power-saving mode or a standby mode can be dispensed with. The control apparatus 1 is therefore less complex and thus less prone to errors and also more cost-effective because the need for the software required or additional controllers, the costs of the microcontrollers including their environment, the space needed for them on the circuit board and the respectively required documentation is eliminated.

By disconnecting the battery or batteries as described above from the control apparatus during long storage periods or when the voltage of the battery or batteries falls below a predetermined minimum, a harmful deep discharge of the battery or batteries is effectively prevented.

In on embodiment of the disclosure, the methods and devices are used to confirm that a remote control signal received by an operating table/control device is from the correct remote control. For example, from the correct infra-red remote control. The control device can use methods and arrangements disclosed herein to avoid implementing an instruction received from the wrong remote control and/or avoid activating the second processor in response to a signal from the wrong remote control. This can for accomplished, for example, by checking whether the received instruction includes an address corresponding to a remote which is paired to that control device or operating table.

The foregoing description of selected embodiments of the present disclosure has been presented for the purpose of illustration and description only and is not to be construed as limiting the scope of the invention in any way. It is intended that the specification and the disclosed examples be considered as exemplary only, with a true scope being indicated by the following claims. The principles and arrangements disclosed throughout this disclosure can be used with tables other than operating tables, and for conserving power in battery operated-devices other than battery-operated tables. The terms “control device” and “control apparatus”, on their own, can be interchangeable, unless modified such as by additional language or limitations.

1. A control device for a battery-operated operating table, the control device comprising:
at least two microprocessors for controlling components of the battery-operated operating table;
an input channel for receiving instructions from an input device;
the control device having an sleep state, a check state, and an active state;
the control device being configured such that in the sleep state thereof: a first microprocessor is in an idle state, the first microprocessor monitors the input channel of the input device, and a second microprocessor is off;
the first microprocessor being further configured to, upon receipt of an instruction via the input channel, switch the control device from the sleep state to the check state in order to check whether the instruction includes a valid wake-up signal;
the control apparatus being adapted wherein the checking includes determining whether the instruction includes an address of the battery-operated operating table, and then, when a valid wake-up signal has been received, to set the control device to an active state;
wherein the first microprocessor and second microprocessor are both active in the active state.

2. The control apparatus according to claim 1, wherein the first and second microprocessors are coupled, respectively, in a master-supervisor structure.

3. The control apparatus according to claim 1, wherein the first microprocessor comprises a power-saving circuit, and is configured such that power consumption of the first microprocessor is lower in the idle state as compared to the active state.

4. The control apparatus according to claim 1, further comprising:
at least one connection for connecting to at least one battery for powering the battery-operated table; and
an electromechanical switch, by means of which the connection for the at least one battery can be electrically disconnected from the control apparatus to prevent further drain of the at least one battery.

5. The control apparatus according to claim 4:
the control apparatus being configured wherein the connection of the at least one battery is automatically electrically disconnected from the control apparatus by means of the electromechanical switch: (i) after a predetermined period of time since the most recent charge and/or (ii) when the battery has discharged below a predetermined voltage value.

6. A battery-operated operating table, comprising:
the control apparatus according to claim 1;
at least one table surface for holding a patient thereon; and
at least one battery.

7. A battery-operated operating table, comprising:
the control apparatus according to claim 1;
at least one table surface for holding a patient thereon;
a battery;
the input device;
at least one motor connected to the battery, the at least one motor configured to at least one of: (i) raise and lower the table surface, and/or (ii) change the orientation of the table surface, and/or (iii) move one or more sections of the table surface with respect to other sections of the table surface to thereby change an overall shape of the table surface.

8. A battery-operated operating table, comprising:
the control apparatus according to claim 1;
at least one table surface for holding a patient thereon;
a battery;
at least one or connected to the battery, the at least one motor configured to at least one of: (i) raise and lower the table surface, and/or (ii) change the orientation of the table surface, and/or (iii) move one or more sections of the table surface with respect to other sections of the table surface to change an overall shape of the table surface;
wherein the at least one input device comprises user controls for adjusting the table surface using the at least one motor;
the control apparatus being configured wherein instructions from the input device to adjust the table surface using the at least one motor constitutes the valid wake-up signal.

9. A method of operating a battery-operated operating table, comprising:
providing the battery-operated operating table of claim 7, with the control device initially in the sleep state thereof;
receiving an input from the input device, and the input device in response sending the instruction to at least the first microprocessor via the input channel;
the first microprocessor, in the idle state, monitoring the input channel and receiving the instruction;
the first microprocessor then determining that the instruction comprises the address of the battery-operated operating table and, in response to the determination, further determining that the instruction includes a valid wake-up signal; and
in response to determining that the instruction includes a valid wake-up signal, setting the control device to the active state, with the first processor and the second processor both being active.

10. A method of operating a battery-operated operating table, comprising:
providing the battery-operated operating table of claim 7, with the control device initially in the sleep state thereof;
receiving an input with the input device, the input comprising a command to adjust the table surface using the at least one motor, and the input device in response sending the instruction to at least the first microprocessor;
the first microprocessor, in the idle state, monitoring the input channel and receiving the instruction;
the first microprocessor then determining that the instruction comprises the address of the battery-operated operating table and, in response to the determination, further determining that the instruction includes a valid wake-up signal;
in response to determining that the instruction includes a valid wake-up signal, setting the control device to the active state with the second processor being active; and
with the control device in the active state, moving the table surface using the at least one motor.

11. The control apparatus according to claim 1, further comprising at least one input device adapted to send instructions to at least one of the microprocessors by means of the input channel.

12. A battery-operated operating table comprising:
one or more plates for supporting a patient thereon;
a motor, the motor positioned for at least one of lifting, tilting, and repositioning the one or more support plates;
a battery;
a control device;
the control device comprising:
at least two microprocessors for controlling components of the battery-operated operating table;
at least one input device adapted to send instructions to at least one of the microprocessors by means of an input channel;
the control device having an sleep state, a check state, and an active state;
the control device being configured such that in the sleep state thereof: a first microprocessor is in an idle state, the first microprocessor monitors the input channel of the input device, and a second microprocessor is off;
the first microprocessor being further configured to, upon receipt of an instruction from the input device, switch the control device from the sleep state to the check state in order to check whether the instruction includes a valid wake-up signal;
the control apparatus being configured wherein said check state includes determining whether the instruction includes a valid wake-up signal and, when the valid wake-up signal has been received, to set the control device to an active state;
wherein the second microprocessor is active in the active state.

13. The battery-operated table of claim 12:
the control device being configured wherein determining that the instruction includes the valid wake-up signal includes confirming that the instruction includes an address of the battery-operated operating table.

14. The battery-operated table of claim 12, wherein the plurality of plates include separately movable leg plates.

15. The battery-operated table of claim 12, comprising:
at least one motor connected to the battery, the at least one motor configured to at least one of: (i) collectively raise and lower the one or more plates, and/or (ii) collectively tilt the one or more plates, and/or (iii) change the orientation of one or more plates with respect to one or more other plates.

16. The battery-operated table of claim 12, comprising:
an electromechanical switch, the electromechanical switch being positioned for controlling an electrical connection between the control device and the battery;
the battery-operated table being configured wherein the electromechanical switch disconnects the control device from the battery in response to at least one of:
passage of a predetermined period of time since a most recent charge of the battery; and/or the battery discharging below a predetermined voltage value.

17. A method of operating a battery-operated operating table, comprising:
providing the battery-operated operating table of claim 12, with the control device initially in the sleep state thereof;
receiving an input with the input device, and the input device in response sending the instruction to at least the first microprocessor;
the first microprocessor, while in the idle state and monitoring the input channel, receiving the instruction;
the first microprocessor then determining that the instruction comprises a valid wake-up signal; and
in response to determining that the instruction include a valid wake-up signal, setting the control device to the active state, with the first processor and the second processor both being active.

18. The method of operating a battery-operated operating table of claim 17:
wherein the step of determining that the instruction includes a valid wake-up signal further comprises determining that the instruction includes an address of the battery-operated operating table.

19. A method of operating a battery-operated operating table, comprising:
providing the battery-operated operating table of claim 12, with the control device initially in the sleep state thereof;
receiving an input with the input device, the input comprising a command to adjust a configuration of the operating table using the at least one motor, and the input device in response sending the instruction to at least the first microprocessor;
the first microprocessor, in the idle state and monitoring the input channel, receiving the instruction;
the first microprocessor then determining that the instruction includes a valid wake-up signal;
in response to determining that the instruction includes a valid wake-up signal, setting the control device to the active state, with the first processor and the second processor both being active; and
with the control device in the active state, moving one or more plates of the battery-operated operating table using at least one motor.

20. A control device for a battery-operated operating table, the control device comprising:
at least two microprocessors for controlling components of the battery-operated operating table;
the control device having an sleep state, a check state, and an active state;
the control device being configured such that in the sleep state thereof: a first microprocessor is in an idle state, the first microprocessor monitors an input channel, and a second microprocessor is off;
the first microprocessor being further configured to, upon receipt of an instruction via the input channel, switch the control device from the sleep state to the check state in order to check whether the instruction includes a valid wake-up signal;
the control apparatus being adapted wherein the checking includes determining whether the instruction includes a valid wake-up signal, and, when and the valid wake-up signal is received, to set the control device to an active state;
wherein the second microprocessor is active in the active state.
